(19) United States
(12) Patent Application Publication
(10) Pub. No.: US 2024/0277451 A1
(43) Pub. Date: Aug. 22, 2024

(54) DEVICES AND METHODS FOR OSSEOUS GRAFT CONVERSION

(71) Applicant: PerioTech, LLC, Palm Beach Gardens, FL (US)

(72) Inventors: Robert A. HOROWITZ, Armonk, NY (US); Richard JOHNSON, Palm Beach Gardens, FL (US)

(21) Appl. No.: 18/652,284

(22) Filed: May 1, 2024

Related U.S. Application Data
(63) Continuation-in-part of application No. 17/836,381, filed on Jun. 9, 2022.
Application No. 17/836,381 is a continuation-in-part of application No. 17/746,332, filed on May 17, 2022.
Application No. 17/746,332 is a continuation-in-part of application No. 17/452,874, filed on Oct. 29, 2021.
(60) Provisional application No. 63/463,280, filed on May 1, 2023.

(51) Int. Cl. A61C 7/08; A61C 7/00

(52) U.S. Cl. CPC A61C 7/08; A61C 7/008

(57) ABSTRACT

A device and method for accelerating the conversion of oral bone graft to alveolar bone following extraction in a patient includes a vibrational dental device having a mouthpiece for contacting the dentition. Instructions are provided for using the vibrational dental device by placing the mouthpiece over the dentition, applying a vibratory force during a predetermined number of sessions throughout a predetermined treatment period, wherein the conversion of bone graft material to mature bone is enhanced and/or accelerated compared to without vibratory treatment.

This application is based upon and claims the benefit of prior U.S. Provisional Patent Application No. 63/463,280, filed on May 1, 2023, the entire content of which is incorporated herein by reference.

### FIELD OF THE DISCLOSURE

This disclosure concerns treatments of oral conditions involving osseous grafts, and more specifically, a method to facilitate complete conversion of graft material formed of natural but innate bone into vital tissue.

### BACKGROUND OF THE DISCLOSURE

It is commonplace to use grafting during oral and periodontal surgery. Grafts essentially serve as scaffolds on which native tissue can proliferate. Grafts can fail when osseointegration is incomplete. In difficult or large defects where ground bone graft material is impractical, block bone grafting is an alternative. Block bone grafting is used in cases of larger defects than in those where particulate graft procedures are adequate. In these cases, a larger piece of living bone is harvested from the patient and used in the area of bone loss.

Larger defects are predictably treated with block grafts, which provide a scaffold for native cells. However, the block graft itself is usually removed from the patient, requiring an additional surgical site to remove the block.

Removal of the block is necessary because even freshly harvested autologous bone quickly loses vitality to become innate bone. In innate bone, the lacunae of the tissue are absent osteocytes. While in some cases the block graft could be left in situ to eventually resorb, it is usually preferable to remove the block graft after it has served its scaffolding role. In a study investigating the fate of viable and dead transplants during the healing of interradicular lesions, both fared similarly. Investigators found that even though a few osteocytes seemed to survive transplantation in the fresh cancellous bone, the osteocyte lacunae were devoid of cells in both types of transplants after only 1 week. The study also found that while the deepest-located bone grafts became incorporated in new bone, more superficially located grafts were rejected or were surrounded by a cementum-like substance. The study concluded that the influence of the grafts on bone regeneration was small and based solely on their osteoconductive (i.e., scaffolding) effect. Ellegaard, B. et al., “The fate of vital and devitalized bone grafts in the healing of interradicular lesions,” J. of Periodontal Research 10:2, pp. 88-97 (April 1975).

In some situations involving trauma or disease, larger bone graft volumes are required. For example, to build up the jaw bone enough to allow for dental implant placement or other restoration procedures. Larger grafts may be taken from the patient's hip, calvariam, or tibia. If the decision is made not to use autogenous (the patient's own) bone as a graft, allograft (cadaver), xenograft (from an animal) or alloplast (synthetic) bone grafts can be used as sole bone grafts or mixed with other types including autogenous bone.

### SUMMARY OF THE DISCLOSURE

According to an exemplary embodiment of the present disclosure, a method for converting osseous graft into vital bone is described. The method includes identifying a patient having a need for oral bone graft material, providing to the patient a vibrational dental device having a mouthpiece for contacting the dentition, and providing instructions for using the vibrational dental device. The instruction includes placing the mouthpiece over the dentition and applying a vibratory force during a predetermined number of sessions throughout a predetermined treatment period. The graft material can be converted to vital bone, which, for most types of bone graft, is practically unachievable in a modern clinical practice without vibratory treatment.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments as set forth in the accompanying claims. Copies of this patent or patent application publication with color drawing(s) will be provided by the Office upon request and payment of the necessary fee.

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure.

FIG. 1A depicts an illustrative vibrational dental device according to one aspect of the disclosure.

FIG. 1B depicts an illustrative vibrational dental device, such as that depicted in FIG. 1A placed in the mouth of a user, according to one aspect of the disclosure.

FIG. 2A is a radiographic view of endosseous dental implants taken more than 10 years after they were placed and had prosthetic restorations inserted, according to one example of the present disclosure.

FIG. 2B is a radiographic view of the implants of FIG. 2A, 2 months following nonsurgical treatment enhanced with an exemplary use of a vibration device for five minutes daily.

FIG. 2C is a radiograph view of the implants of FIG. 2A following thirteen months after non-surgical peri-implant therapy with an exemplary use of a vibration device for five minutes daily.

FIG. 3A is a chart showing comparison of the number of PDL fibroblasts in a site between non-vibrated control and LMHFV 120 Hz over a 3-day period demonstrating statistically significant increases with the LMHFV.

FIG. 3B is a chart showing comparison of osteoblasts between non-vibrated control and LMHFV 120 Hz over a 3-day period demonstrating statistically significant increases with the LMHFV.

FIGS. 4A-4F depict an illustrative molar bone conversion example with utilization of the LMHFV device, consistent with some disclosed embodiments.

FIG. 5 is an appearance bone graft without using LMHFV device.

FIGS. 6A-6F depict an illustrative upper teeth bone conversion example with utilization of the LMHFV device, consistent with some disclosed embodiments.

FIGS. 7A-7B are histologic bone conversion examples with utilization of the LMHFV device, consistent with some disclosed embodiments.

FIG. 8 is an example histologic bone graft results without using LMHFV device.

Reference will now be made in detail to exemplary embodiments. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

### DETAILED DESCRIPTION

It is to be understood that both the foregoing general description and the following detailed description are exemplary and explanatory only and are not restrictive of the claims.

The disclosed embodiments relate to devices, systems, and methods for converting bone graft material to vital bone. Advantageously, embodiments of the present disclosure can be implemented to convert graft material to mature, vital bone, which has not been possible in a clinical setting. This is surprising in light of the generally held view that mechanical disruption of a graft site is detrimental to osseointegration.

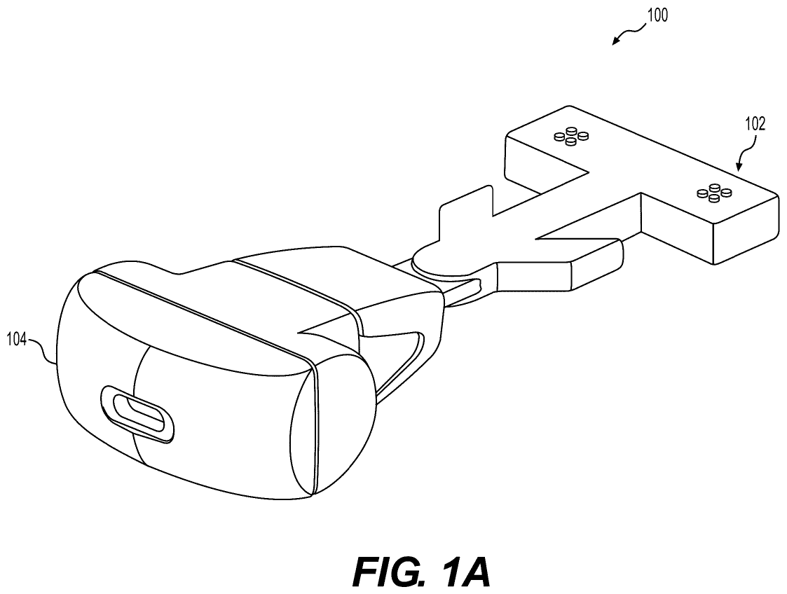

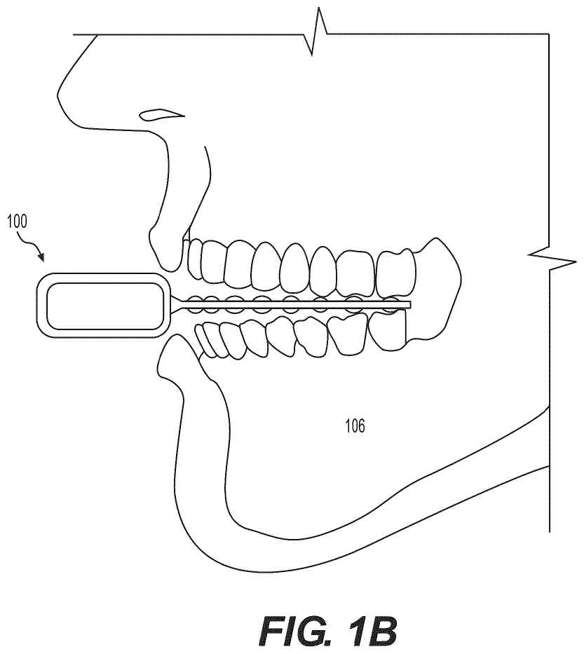

LMHFV, as indicated may be utilized immediately following implant placement when insertion torque so dictates, for example when sufficient torque to immediately load, or when clinical circumstances will not permit immediate loading, for example, insufficient insertion torque. In an aspect, with reference to FIGS. 1A and 1B, use of the device 100 providing LMHFV for 5 minutes daily accelerates osseous healing through osteogenic cell stimulation, with increased growth factor expression and angiogenesis stimulation permitting earlier loading. Further advantageously, bone density improvement is observed contributing to implant stability and better overall oral health.

Described herein are LMHFV dental devices, which in certain embodiments include a mouthpiece configured to transmit vibration to the biting, incisal or occlusal surfaces of all or a portion of the patient's teeth.

Referring to FIGS. 1A-1B, an exemplary dental device 100 includes a mouthpiece 102 operatively connected to a housing 104. The mouthpiece 102 can be separable from the housing 104 for interchangeability between users or for ease of cleaning. The mouthpiece 102 can include one or more oral tissue-contacting portion, such as a biteplate or probe for contacting teeth, gums or other oral tissues. As shown, in FIG. 1A, the mouthpiece can include a biteplate which can be appropriately shaped to cover occlusal surfaces of some or all of a patient's dentition. Other shapes for the mouthpiece are possible. For example, the mouthpiece can be configured to abut the lingual and buccal lateral sides of the alveolar ridge either with or without occlusal contact or, when no teeth are present, contact with gums overlying the alveolar ridge. A vibration generator can be located in the mouthpiece 102 or the housing 104 to vibrate the mouthpiece 102. The housing 104 can also include the electronics to run the motor of the vibrator, collect usage and device operation data, collect data from sensors in the mouthpiece or base, and store data in memory. The housing 104 can include a data interface which can be wired or wireless to allow a data connection to other devices. The housing 104 can also include a power interface to allow charging of any onboard power sources, such as batteries or capacitor banks. The mouthpiece 102 can be electrically interconnected to the housing 104. FIG. 1B depicts an illustrative dental device 100, such as that described above with reference to FIG. 1A, inserted in the mouth of a human user 106 and engaging the occlusal surfaces of the molars. The mouthpiece of the dental device 100 can, as described above, be sized and shaped to contact any dental tissue, including some or all of the teeth, specific regions of the gums, or both.

As is known in the art, the vibration generator can include an electric motor connected to an eccentric weight, or can be a piezo generator, as well as other known expedients. Accordingly, when the mouthpiece 102 is placed in a patient's mouth and the dental device 100 is turned on, the vibration of the mouthpiece 102 will place vibratory force repetitively on the teeth and/or other oral tissues.

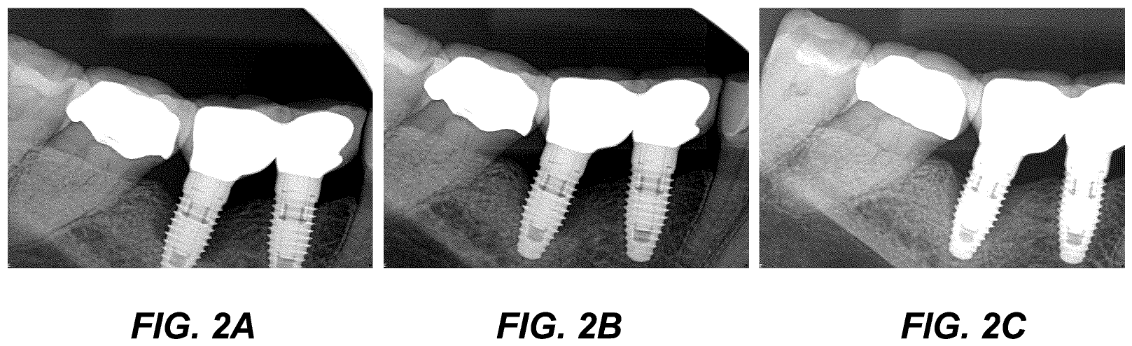

FIG. 2A is a radiograph view showing bone implants after more than 10 years of the implants being placed, peri-implant infection and bone loss has occurred. The distal (left) implant has lost significant bone. That implant as well as the adjacent tooth and implant are clearly at risk of loss of bone and the affected implant is at risk of being exfoliated (lost). A blood blot acting as an osseous grafts was placed surrounding the implant. The patient was instructed on the use of LMHFV. Once loading is initiated, continued use of LMHFV will continue to further increase bone density around the implants improving their long-term prognosis through better load handling. In an example, the appliance may be used long-term as an at home therapy to preserve bone to implant contact (BIC) and potentially prevent peri-implantitis. FIG. 2B is a view of the implant in FIG. 2A after two months of healing and graft/clot integration and with use of an illustrative dental device according to the present disclosure for five minutes daily. The density and proliferation of vital bone has very closely approximated the implant surface and appears as vital bone. In clinical practice, this can occasionally happen after perhaps 12 months or more in only certain relatively rare cases. That such results were obtained after only two months is surprising.

FIG. 2C is a view of the implant in FIG. 2A after thirteen months of integration, non-surgical peri-implant therapy, with use of an illustrative dental device according to the present disclosure for five minutes daily. FIG. 2C shows the continued mineralization and bone apposition demonstrating the long-lasting effect of this procedure, improving the prognosis of the treated implant. FIG. 2C clearly demonstrates that there has been an improvement in the bone level around the entire implant. Additionally, the periodontal pockets, which are spaced between the teeth and gums, have decreased from 10 mm to a range of 4-5 mm. This is significant because a dental implant or tooth with a periodontal pocket depth of 10 mm has a hopeless prognosis, meaning that it is unlikely to be able to be maintained. With probing depths in the range of 4 mm to 5 mm, the prognosis is now good to excellent that the tooth or implant can be maintained for the patient's lifetime.

In this case of FIGS. 2B-2C, where a patient had a defect that was filled with a scaffold of “graft material.” The graft material was a combination of a blood clot and an amnion-chorion membrane. This case demonstrates a high volume of conversion of the blood clot to vital bone through radiographic analysis. If a traditional mineralized bone graft had been placed in this particular site, it would have blocked radiographic analysis of healing. Additionally, the mineralized bone graft could have become embedded in soft tissue, harbor bacteria, and not performed any useful biologic task. However, just by not having been expelled from the surgical site, the graft could appear to have healed. When, in a case like this, the radio-opacity returns in the absence of placement of a mineralized bone graft, this result can only be due to the formation of new bone in the healed site. The use of a vibration device, which enhanced both the speed and total volume of new bone formation compared to what is typically reported in the literature.

In another aspect, LMHFV offers the same effects of converting osseous graft material to vital bone, so that a dental implant may be placed into higher quality bone sooner than when LMHFV is not utilized. As shown in examples hereafter, the resorbable bone grafts are synthetics (alloplasts) that don't contain hydroxyapatite that can be fully replaced by bone or become vital in the absence of growth factors.

The vibration can be applied along multiple axes or selected to be primarily on a single axis. The primary anatomic reference directions with reference to a standing human are superior-inferior (up and down), anterior-posterior (front to back), medial-lateral (side to side). Because mastication places loading on oral structures primarily in the superior-inferior direction through mandibular action, it may be advantageous to choose vibrational loading along other axes either separately or in combination.

The vibration can further be applied to soft tissues. The vibration from LMHFV can stimulate the proliferation and activation of fibroblasts. The increased fibroblasts can further enhance collagen formation and accumulation in native soft tissue. Collagen is the primary structural protein, along with other connective tissues throughout the face. The increased level of collagen can effectively firm the aging tissue and shorten the recovery duration of injured or post-surgical tissues.

### Vibrational Dental Devices

According to an aspect of the present disclosure, a vibrational dental device that vibrates at one or more predetermined frequencies is provided. In some embodiments the vibrational frequency is fixed within a lower bound and an upper bound. The lower bound can be greater than about 110 Hz, 105 Hz, 100 Hz, 95 Hz, 90 Hz, 85 Hz, 80 Hz, 75 Hz, 70 Hz, 65 Hz, 60 Hz, 55 Hz, 50 Hz, 45 Hz, or less. The upper bound can be greater than about 115 Hz, 120 Hz, 125 Hz, 130 Hz, 135 Hz, 140 Hz, 145 Hz, 150 Hz, or more. In some embodiments, the frequency varies within a lower and an upper bound. In some embodiments two or more frequencies, fixed or varying, are employed.

In some embodiments the duration of a treatment session can be specified to be greater than about 30 seconds, 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, or more; or specified to be less than about 20 min, 19 min, 18 min, 17 min, 16 min, 15 min, 14 min, 13 min, 12 min, 10 min, 9 min, 8 min, 7 min, 6 min, 5 min, 4 min, 3 min, 2 min, 1 min, 30 seconds, or less.

FIG. 1 depicts a vibrational dental device according to an example. The vibrational dental device can include a mouthpiece and a vibrational source connected to each other. The mouthpiece is configured to be provided between the occlusal surfaces of a user's teeth, and to be bite down by the user to contact the user's dentition during the treatment. The mouthpiece can cover at least the teeth or implant around which accelerating graft conversion is desired. The vibrational source is configured to provide vibration to the mouthpiece at a preset frequency and acceleration.

To achieve the maximum desired results of graft conversion, further studies are still needed to optimize the clinical parameters of LMHFV. Such parameters may include frequency, acceleration, and dosage. Dosage may include duration per use, number of uses per day, or number of days of use, either consecutively or at a certain schedule.

In some embodiments, the vibrational source may be connected to the mouthpiece in such way that the vibration provided is in the sagittal plane of a user's mouth. A motor may be included in the vibrational source to provide such vibration. The motor may be of any suitable type known in the art. The motor, when in use, may be configured to provide vibration at a frequency as disclosed herein. The motor, when in use, may be further configured to provide vibration at an acceleration magnitude. In some embodiments the mouthpiece of a dental vibration device can have an acceleration within a lower bound and an upper bound. The lower bound can be greater than about 0.010 G, 0.015 G, 0.020 G, 0.025 G, 0.030 G, 0.035 G, 0.040 G, 0.045 G, 0.050 G, 0.055 G, 0.060 G, or more; or less than about 0.060 G, 0.055 G, 0.050 G, 0.045 G, 0.040 G, 0.035 G, 0.030 G, 0.025 G, 0.020 G, 0.015 G, 0.010 G, or less. The upper bound can be greater than about 0.07 G, 0.08 G, 0.09 G, 0.10 G, 0.11 G, 0.12 G, 0.13 G, 0.14 G, 0.15 G, or more; or less than about 0.15 G, 0.14 G, 0.13 G, 0.12 G, 0.11 G, 0.10 G, 0.09 G, 0.08 G, 0.07 G, or less.

The motor may be assembled into the vibrational source in an orientation that may provide vibration in such ways.

In some embodiments, sensors may be added to the vibrational dental device, either on the vibrational device, or on the mouthpiece. The sensors may be configured to detect and monitor the parameters of the vibration, for example, frequencies and acceleration magnitudes. The sensors may also be configured to detect if the user has bitten down on the mouthpiece correctly. The sensors may be accelerometers, gyroscopes, proximity sensors, pressure sensors, humidity sensors, temperature sensors, or any combinations of them.

In some embodiments, the mouthpiece could be in contact with at least the teeth or implant near which graft conversion acceleration is needed. The mouthpiece may be configured to be placed in contact with a user's dentition, between and clamped down by both occlusal surfaces of the dentition. The mouthpiece can include ridges or be without ridges. The mouthpiece can cover the entire dentition, or only a part of the dentition. The shape of the mouthpiece can be customized to cover only selected teeth or implants.

### Method for Accelerating Graft Material Conversion

According to yet another aspect of the present disclosure, a method for converting graft material to vital bone is described. The method includes providing the mouthpiece of the vibrational dental device to a user and providing instructions to the user. The instruction may include placement guidelines and dosage information. The dosage information may include duration of each treatment session, number of sessions in a day, number of days, etc. For example, the instruction may instruct a user to use the vibrational dental device for number of times per day. In some embodiments the treatment frequency can be specified to be once per day, twice per day, 3 times per day, 4 times per day, 5 times per day, 6 times per day, 7 times per day, 8 times per day, 9 times per day, or more. In some embodiments the duration of treatment can be specified to be about 1 day, 1 week, 2 weeks, 3 weeks, 1 month, 2 months, 3 months, 4 months, 5 months, 6 months, 7 months, 8 months, 9 months, 10 months, 11 months, 1 year, or more.

In some embodiments, the method may further include configuring the vibrational source providing an axial vibratory force to the mouthpiece. The axial vibratory force may be eventually applied to the dentition through the mouthpiece, which is clamped down by the teeth. The vibratory force (e.g., acceleration magnitudes, frequencies, etc.) can be adjusted by selecting preset values, or fine-tuned by users, technicians, or healthcare professionals.

### EXAMPLES

On Apr. 6, 2022, the lower left molars (nos. 18 and 19) were extracted on a 50 year old male patient. The sockets were debrided. The adjacent tooth (no. 20) was root planed and treated with citric acid. All sites grafted with L-PRF block of Maxxeus Cortico Cancellous mineralized allograft hydrated in leukocyte enriched Platelet Rich Fibrin (L-PRF). An amnion-chorion barrier covered with an L-PRF barrier was placed. Buccal and lingual coronally repositioned flaps (CRF) were closed with poly glycolic acid sutures. Hemostasis was achieved. The patient tolerated procedures well. Pre-intra-postoperative images and periapical x-rays were taken. Patient was given the LMHFV device.

A post-operative checkup showed the sites healing well, with certain sutures dislodged and minimal food impaction at crest. Periapical imaging showed excellent retention of graft material.

On May 12, 2022, a lower right molar (no. 30) was extracted. The socket was debrided of significant quantities of granulation tissue and grafted with Maxxeus Cancellous mineralized allograft in saline. A barrier of 2 layers of Bx was placed. CRF buccal and lingual flaps were closed with PGA sutures. Hemostasis was achieved. Patient tolerated procedures well.

The patient was provided with a LMHFV device as described herein and provided by PerioTech, LLC and given instructions for use and cleaning. Pre-intra- and postoperative images and periapical x-rays were taken.

In January 2023, the patient was evaluated for bone graft quality via core sampling, and implants were placed at teeth nos. 13,18,19 and 30. Cores were taken at locations 18, 19 and 30 and one control core from a non-grafted location at site 13. The grafted, vibration treated sites all healed well. BioTech Dental Kontact endosseous implants were placed at sites of nos. 13, 18 and 19 and were all fully stable. Grafts were placed around all healing abutments with same graft as used in the extraction therapy. An L-PRF barrier was placed on the buccal and proximal areas between implant #s 18 and 19. Buccal and lingual flaps were repositioned and closed with cytoplast sutures. Hemostasis was achieved. The patient tolerated procedures well. Pre-intra-postoperative images and periapical x-rays were taken.

In another patient, an 81-year-old male, treated in similar manner as above, the core samples revealed that the grafted site was much higher in vital bone content than would have been expected with conventional grafting, and much higher than would have been expected with no grafting. The control site was much softer bone than the grafted site. Most surprisingly, the lacunae in the grafted bone were full of vital cells. This was entirely unexpected and has not been reported in the dental nor orthopedic literature.

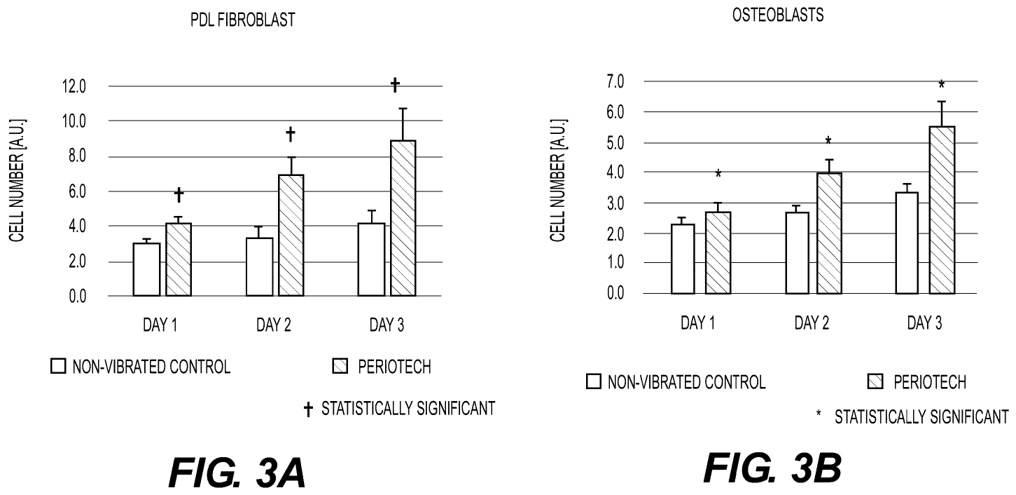

FIG. 3A is a chart showing comparison of PDL fibroblast between non-vibrated control and LMHFV 120 Hz over a 3-day period demonstrating statistically significant increases with the LMHFV. FIG. 3B is a chart showing comparison of osteoblasts between non-vibrated control and LMHFV 120 Hz over a 3-day period demonstrating statistically significant increases with the LMHFV.

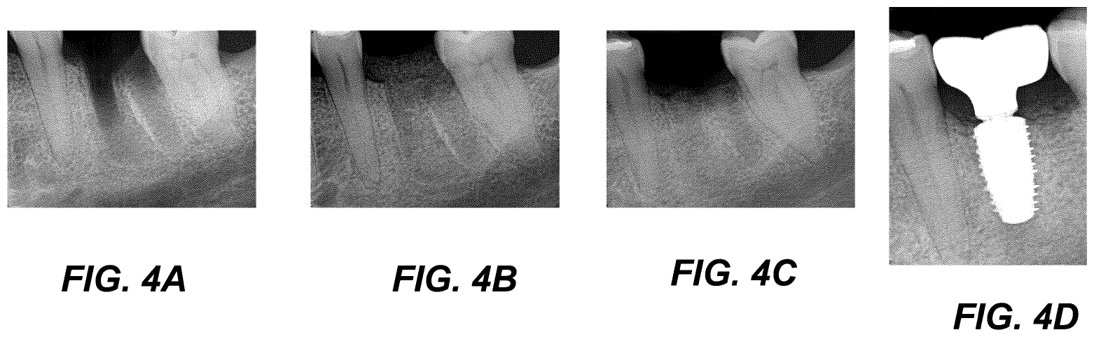

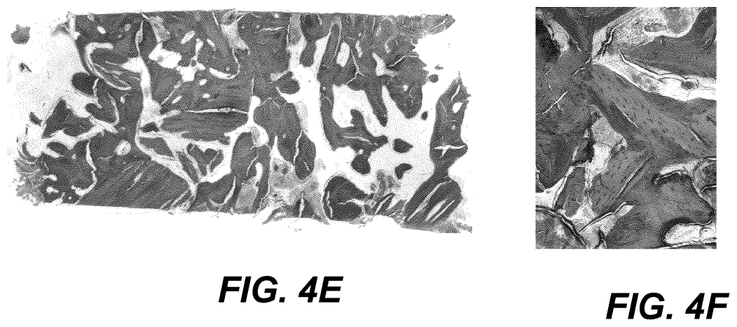

FIGS. 4A-4F depict a third bone conversion example with utilization of the LMHFV device. The fractured, infected lower molar was sectioned and extracted. As shown in FIG. 4A, the socket was debrided. FIG. 4B is an Xray depicting the site as grafted with an L-PRF block of mineralized allograft. The L-PRF block was covered with amnion chorion and collagen barriers. The patient was provided with a LMHFV device as described herein and provided by PerioTech, LLC and given instructions for use and cleaning. As shown in FIG. 4C, the graft appeared similar to bone 9 months later, both height and width of the graft was preserved. The implant in FIG. 4D was placed nine months after grafting. As shown in the histologic analysis of retrieved core in FIGS. 4E and 4F, 75% of the bone were vital. The red-pink color represented vital bone and osteocytes in lacunae. According to the dental literature, in this portion of the maxillary arch (upper jaw), the normal percentage of vital bone is 35%.

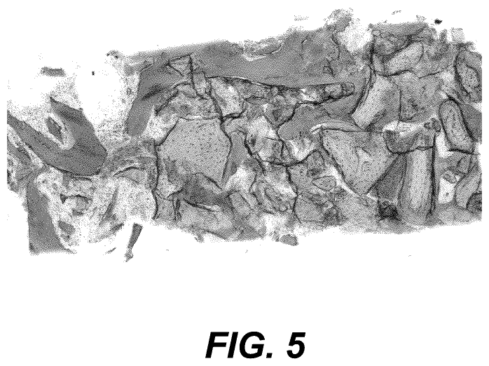

In contrast to example in FIGS. 4A-4F, FIG. 5 depicts an appearance of bone graft without using LMHFV device for a patient with similar age, same site, and same extract processing. The graft had the same stain, it appeared dead with only 25-35% of the bone by volume was vital. There were no osteocytes in lacunae of the grafted particles. There was almost no linking of graft particles with vital bone.

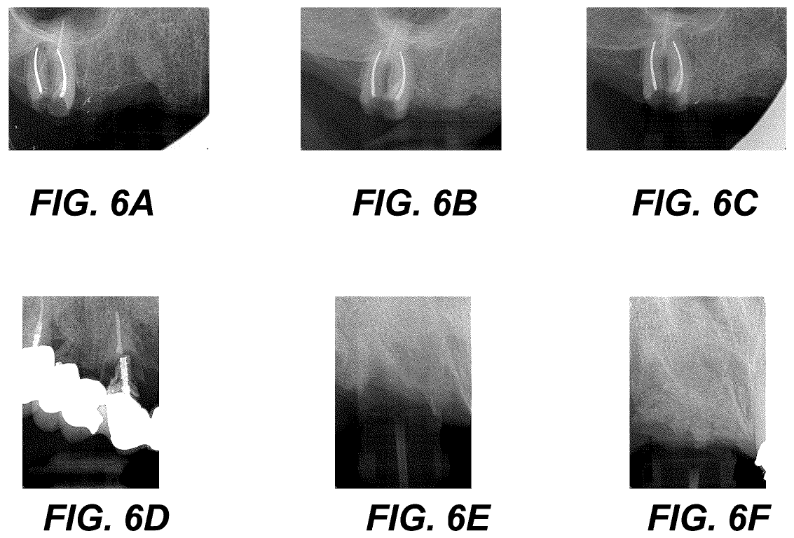

FIGS. 6A-6F depict a fourth bone conversion example with utilization of the LMHFV device. The patient at age of 81 has significant bone loss, severe decay, and infected, non-maintainable teeth. The upper teeth on the right side were extracted and the sockets were debrided. All sites were grafted with an L-PRF block of mineralized allograft to regain ideal bucco-lingual and apico-coronal dimensions. The bone graft was covered with an Amnion Chorion barrier. The patient tolerated the procedures well. Pre-intra- and postoperative images and periapical x-rays were taken. The patient was given the LMHFV device with instructions for use and cleaning.

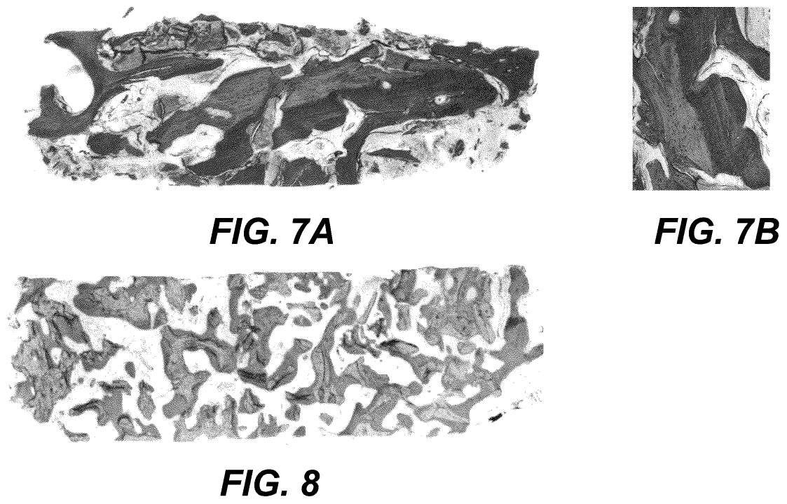

Five months later, the healed sites in FIGS. 6C and 6F showed that bone appeared normal, and preserved width and height at the post-operative checkup. Histologic analysis of retrieved core in FIGS. 7A and 7B shows 55% bone were all vital. Osteocytes were in lacunae and former graft particles turned to vital and graft particles linked together. In contrast, the comparison test results of a patient with similar age and site without using LMHFV device presented a lower rate of vital bone and graft as shown in FIG. 8.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for converting osseous graft to vital bone, comprising:
identifying a patient having oral bone graft material;
providing to the patient a vibrational dental device having a mouthpiece for contacting the dentition; and
providing instructions for using the vibrational dental device, the instruction comprising:
placing the mouthpiece over the dentition;
applying a vibratory force during a predetermined number of sessions throughout a predetermined treatment period;
wherein the graft material is converted to mature bone faster than without vibratory treatment.

2. The method of claim 1, wherein the frequency is ranging from 45 Hz to 150 Hz.

3. The method of claim 1, wherein the duration is ranging from 30 seconds to 20 minutes.

4. The method of claim 1, wherein the acceleration of the mouthpiece ranged from 0.010 G to 0.15 G.

5. The method of claim 2, wherein the frequency is about 113 Hz.

6. The method of claim 1, wherein the session time is from 30 seconds to 20 minutes.

7. The method of claim 1 where sessions are repeated daily, every other day, semi-weekly, or weekly.

8. The method of claim 1, wherein the treatment period is from 1 day to 1 year.

9. The method of claim 1, wherein the bone graft is autograft.

10. A method for accelerating graft conversion to alveolar bone, comprising:
identifying a patient having bone graft material placed around an exposed portion of a dental implant, and one or more teeth comprising the patient's dentition;
providing to the patient a vibrational dental device having a mouthpiece for contacting the dentition and/or the dental implant; and
providing instructions for using the vibrational dental device, the instruction comprising:
placing the mouthpiece over the dentition;
applying a vibratory force during a predetermined number of sessions throughout a predetermined treatment period;
wherein the graft material is converted to mature bone faster than without vibratory treatment.
